(19) United States
(12) Patent Application Publication
(10) Pub. No.: US 2020/0168373 A1
(43) Pub. Date: May 28, 2020

(54) VARISTOR

(71) Applicant: SAMSUNG ELECTRO-MECHANICS CO., LTD., Suwon-si (KR)

(72) Inventors: Ic Seob KIM, Suwon-si (KR); Jung Il Kim, Suwon-si (KR); Hae In Kim, Suwon-si (KR); Yong Sung Kim, Suwon-si (KR)

(21) Appl. No.: 16/572,123

(22) Filed: Sep. 16, 2019

(30) Foreign Application Priority Data
Nov. 22, 2018 (KR) 10-2018-0145557

(51) Int. Cl. H01C 7/12; H01C 1/142; H01C 17/065; H01C 17/28

(52) U.S. Cl. CPC H01C 7/12; H01C 17/281; H01C 17/065; H01C 1/142

(57) ABSTRACT

A varistor includes a substrate, a varistor body disposed on one surface of the substrate, first and second electrodes disposed on the varistor body and spaced apart from each other, an insulating layer disposed on at least two of the first and second electrodes and the varistor body, and first and second terminals disposed on first and second sides of the substrate opposing each other, electrically connected to the first and second electrodes, respectively, and spaced apart from each other. The substrate has mechanical strength greater than that of the varistor body.

### CROSS-REFERENCE TO RELATED APPLICATION(S)

This application claims benefit of priority to Korean Patent Application No. 10-2018-0145557 filed on Nov. 22, 2018 in the Korean Intellectual Property Office, the disclosure of which is incorporated herein by reference in its entirety.

### TECHNICAL FIELD

The present disclosure relates to a varistor.

### BACKGROUND

Generally, information communication devices such as advanced IT terminals, and the like, have been designed to have increased integration density, to use a semiconductor device/chip/module in which fine line width technology is applied, and to use a high efficiency passive device such as a multilayer ceramic capacitor (MLCC) to reduce a size and to use low power.

However, such a semiconductor device/chip/module may be vulnerable to withstand voltage, and the like, such that a semiconductor device/chip/module may be broken or may malfunction due to a surge or electrostatic discharge (ESD) caused in various routes.

A varistor may be used to absorb a surge or to filter electrostatic discharge.

Further, there has been a recent trend in which automobiles are being rapidly developed as highly advanced electronic products, rather than mechanical products, according to ICT convergence.

A semiconductor device/chip/module and a passive device included in such an automobile may also be broken or malfunction due to a surge or electrostatic discharge.

For example, if an automotive smart car malfunctions for such reasons, the safety of the driver and pedestrians may be compromised. Accordingly, it may be important to prevent a surge from flowing into a circuit and to control a surge.

Thus, an automobile may use a varistor for protecting a semiconductor device/chip/module.

As described above, a varistor has been increasingly used in various fields, and is required to have high reliability to respond to various fields.

For example, a varistor used in a relatively poor environment, such as an automotive application component, is required to have relatively high strength, and that used in an IT terminal is required to have improved mechanical strength compared to unit size, so as to be advantageous in miniaturization/slimming thereof. A factor in determination of mechanical strength of the varistor is a grain boundary thereof; however, it is difficult to obtain high mechanical strength with only the grain boundary.

### SUMMARY

An aspect of the present disclosure is to provide a varistor having improved mechanical strength and/or a structure advantageous in miniaturization/slimming thereof.

According to an aspect of the present disclosure, a varistor includes a substrate, a varistor body disposed on one surface of the substrate, first and second electrodes disposed on the varistor body and spaced apart from each other, an insulating layer disposed on at least two of the first and second electrodes and the varistor body, and first and second terminals disposed on first and second sides of the substrate opposing each other, electrically connected to the first and second electrodes, respectively, and spaced apart from each other. The substrate has mechanical strength greater than that of the varistor body.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a varistor according to an example embodiment of the present disclosure;

FIGS. 2A to 2C are side views of a varistor according to an example embodiment;

FIGS. 3A to 3C are plan views of a varistor according to an example embodiment;

FIGS. 4A to 4C are side views of up and down displacement of electrodes of a varistor according to an example embodiment; and

FIG. 5 is a flowchart illustrating a process of manufacturing a varistor according to an example embodiment.

### DETAILED DESCRIPTION

Hereinafter, embodiments of the present disclosure will be described as follows with reference to the attached drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another example embodiment without departing from the spirit and scope of the present disclosure. Shapes and sizes of elements in the drawings may be exaggerated for clarity of description, and the same elements will be indicated by the same reference numerals.

For clarity of description, some elements may be omitted or briefly illustrated, and thicknesses of elements may be magnified to clearly represent layers and regions.

It will be understood that when a portion “includes” an element, it can further include another element, not excluding another element, unless otherwise indicated.

With respect to directions of a hexahedron, L, W, and T indicated in the drawings are defined as a length direction, a width direction, and a thickness direction, respectively.

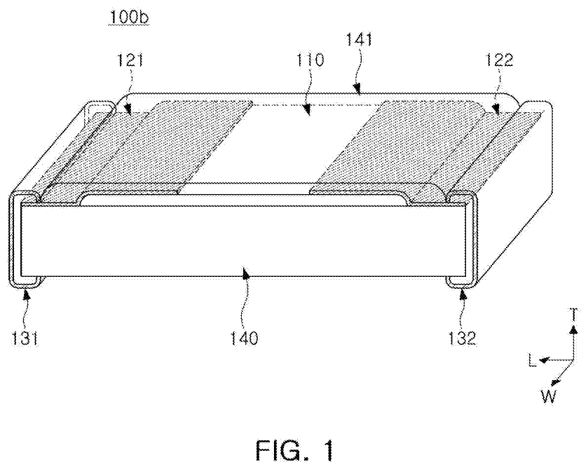

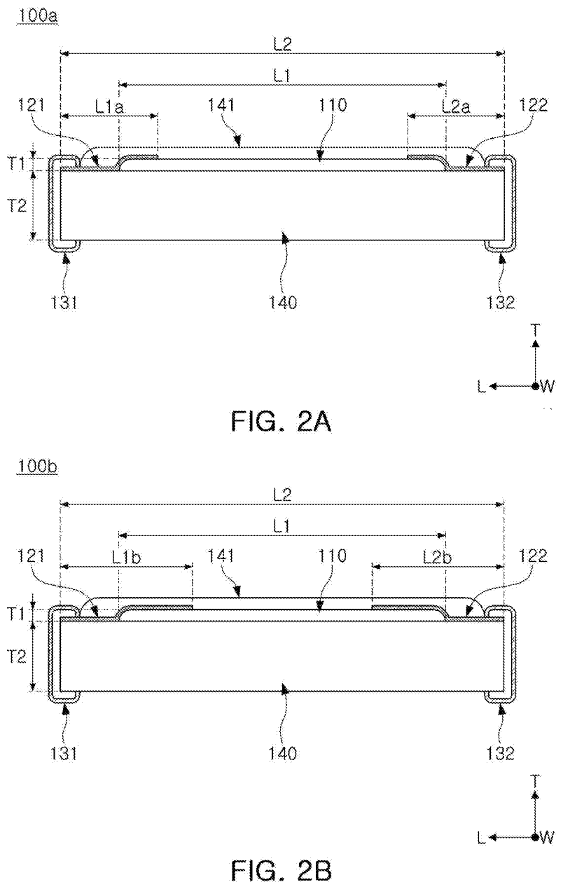

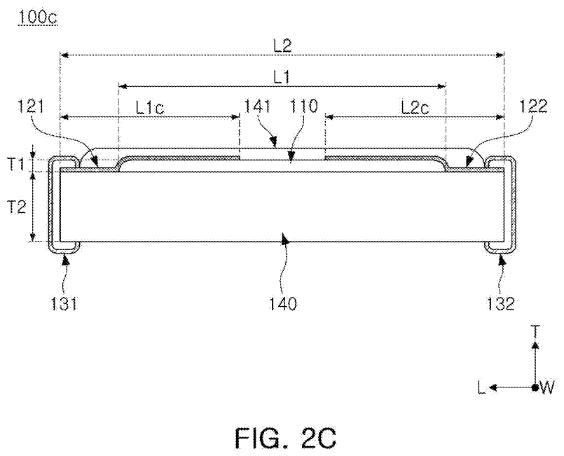

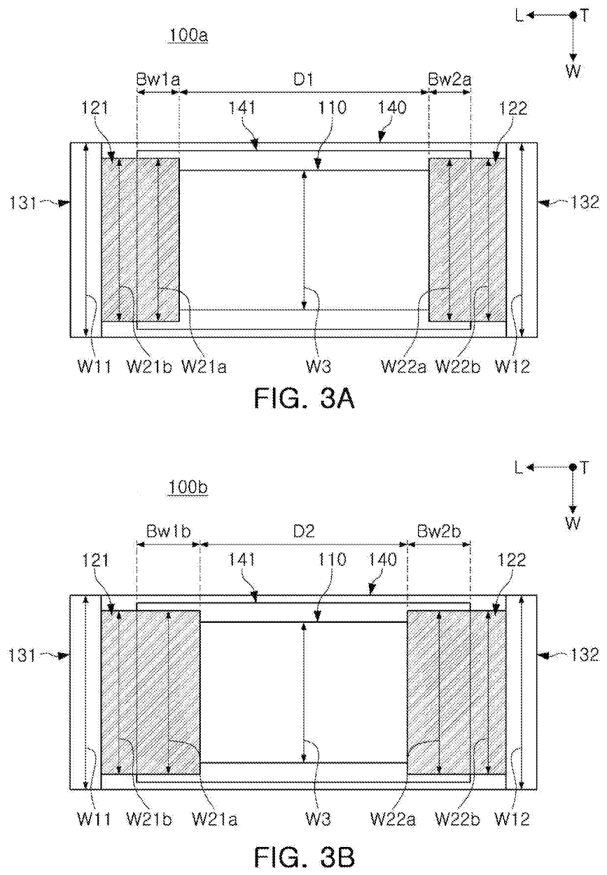

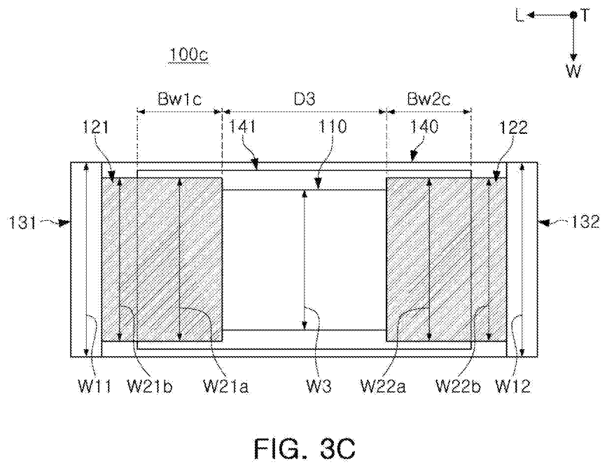

FIG. 1 is a perspective view of a varistor according to an example embodiment of the present disclosure, and FIGS. 2A to 2C are side views of a varistor according to an example embodiment. FIGS. 3A to 3C are plan views of a varistor according to an example embodiment.

Referring to FIGS. 1 to 3C, a varistor 100a, 100b or 100c according to an example embodiment includes a varistor body 110, a first electrode 121, a second electrode 122, a first terminal 131, a second terminal 132, an insulating layer 141 and a substrate 140. In the varistor body 110, the first and second electrodes 121 and 122 may be disposed on a same surface. For example, the first and second electrodes 121 and 122 may be disposed on a same surface of the varistor body 110.

In the varistor body 110, a resistance value between a plurality of points may change, depending on voltage applied between the plurality of points. Thus, I-V (current-voltage) properties of the varistor body 110 may be nonlinear. For example, the varistor body 110 may include ZnO and may be implemented as a ZnO—Bi₂O₃ based varistor body and a ZnO—Pr₆O₁₁ based varistor body, and may include additives such as silicon (Si), bismuth (Bi), cobalt (Co), manganese (Mn), zirconium (Zr), antimony (Sb) and zinc (Zn). The additives may be related to the formation of a secondary crystalline phase and the formation of a liquid phase of the varistor body 110.

For example, the varistor body 110 may be formed thin by printing a ceramic solid powder paste on the substrate 140.

The first and second electrodes 121 and 22 are respectively disposed on the varistor body 110 and spaced apart from each other. When voltage applied between the first electrode 121 and the second electrode 122 is low, the varistor body 110 has high resistance, thereby insulating the first electrode 121 and the second electrode 122 from each other.

The resistance of the varistor body 110 can be reduced as the voltage between the first electrode 121 and the second electrode 122 increases, and can be significantly reduced when the voltage is higher than a respective breakdown voltage of the varistor 100a, 100b and 100c.

That is, the voltage applied between the first electrode 121 and the second electrode 122 is concentrated on a shortest route between the first electrode 121 and the second electrode 122 inside the varistor 100a, 100b and 100c, thereby forming an electric field. The electric field can accumulate electrons at one end of the first electrode 121 and one end of the second electrode 122 and stack the electrons along the shortest route. A height of the stacked electrons increases as magnitude of the electric field increases.

When the electric field magnitude is greater than a magnitude corresponding to the breakdown voltage, the one end of the first electrode 121 and the one end of the second electrode 122 may act as an electrical path.

The breakdown voltage of the varistor 100a, 100b and 100c may become higher as the shortest route between the first and second electrodes 121 and 122 are longer. That is, the varistor 100a, 100b and 100c can have various breakdown voltages by adjusting an extension length of the first electrode 121 and/or the second electrode 122.

The first and second terminals 131 and 132 are electrically connected to the first and second electrodes 121 and 122, respectively, and spaced apart from each other, and may be disposed on one side (e.g., left side surface) and the other side (e.g., right side surface) of the substrate 140.

The first and second terminals 131 and 132 may extend in a length direction along one surface of the substrate 140 on which the varistor body 110 is disposed. Each width (W21a, W21b, W22a and W22b) of the first and second electrodes 121 and 122 may be smaller than that (W11 and W12) of the first and second terminals 131 and 132. For example, the width W21a may refer to a width of a portion of the first electrode 121 disposed on the varistor body 110, the width W21b may refer to a width of a portion of the first electrode 121 disposed on the one surface of the substrate 140, the width W22a may refer to a width of a portion of the second electrode 122 disposed on the varistor body 110, and the width W22b may refer to a width of a portion of the second electrode 122 disposed on the one surface of the substrate 140. The width W11 may refer to a width of a portion of the first terminal 131 extending onto the one surface of the substrate 140 to cover a portion of the first electrode 121, and the width W12 may refer to a width of a portion of the second terminal 132 extending onto the one surface of the substrate 140 to cover a portion of the second electrode 122.

Accordingly, the varistors 100a, 100b and 100c can reduce occurrence of a spark in terms of a width direction of the varistor body 110, and thus can have stable characteristics (for example, breakdown voltage, EDS noise absorption, etc.).

Further, the width (W3) of the varistor body 110 may be smaller than each width (W21a, W21b, W22a and W22b) of the first and second electrodes 121 and 122. Accordingly, the varistor 100a, 100b and 100c can prevent deteriorations of reliability caused by smearing of the varistor body 110 toward the side surfaces of the substrate 140 on the substrate 140, and thus can have more stable characteristics and higher durability.

The insulating layer 141 is disposed on at least two of the first and second electrodes 121 and 122 and the varistor body 110. Accordingly, the insulation capacity between the first and second electrodes 121 and 122 can be adjusted and improved.

For example, the insulation layer 141 may be formed of an insulating material such as a glass, an epoxy, SiO₂, Al₂O₃, an organic material, or the like, and may have a structure in which two types of the insulating materials are respectively disposed on the upper and lower part of the insulating layer.

At least a portion of each of the first and second electrodes 121 and 122 is bent to be disposed on an upper side of the varistor body 110. For example, a portion of each of the first and second electrodes 121 and 122 is disposed directly on the one surface of the substrate 140, and another portion of each of the first and second electrodes 121 and 122 is bent from the portion thereof disposed directly on the one surface of the substrate 140 to extend onto a portion of the varistor body 110. Accordingly, the varistor 100a, 100b and 100c may have improved mechanical strength and a structure advantageous in miniaturization thereof.

As the insulating layer 141 can cover the first and second electrodes 121 and 122 disposed on the upper side of the varistor body 110, the occurrence of a spark on the upper side of the varistor 110 can be prevented between the first and second electrodes 121 and 122. Opposing end portions of the first and second electrodes 121 and 122 may be exposed from the insulation layers 141, such that the opposing end portions of the first and second electrodes 121 and 122 may be covered by and contact with the first and second terminals 131 and 132, respectively.

The substrate 140 provides one side (e.g., left side surface) on which at least a portion of the first terminal 131 is disposed, the other side (e.g., right side surface) on which at least a portion of the second terminal 132 is disposed, and one surface (e.g., an upper surface) on which the varistor body 110 is disposed, and has higher mechanical strength than the varistor body 110.

The mechanical strength is defined as magnitude of force generated at a moment when the varistor body 110 or the substrate 140 is broken (e.g., cracked or cut) when the force applied to the upper and lower surfaces of the varistor body 110 or the substrate 140 gradually increases. In other words, when the substrate 140 has higher mechanical strength than the varistor body 110, the substrate may be broken when greater force is applied to the upper or lower surface thereof than to the varistor body 110.

The varistor 100a, 100b or 100c according to an example embodiment can support the varistor body 110 using relatively great strength of the substrate 140, and thus can have further improved mechanical strength.

In addition, the varistor 100a, 100b or 100c according to an example embodiment can have improved mechanical strength with respect to overall thicknesses of the substrate 140 and the varistor body 110. The varistor 100a, 100b and 100c can have mechanical strength, higher than standard mechanical strength, while reducing the thicknesses of the substrate 140 and the varistor body 110, and thus can be miniaturized.

For example, the substrate 140 may be formed of an alumina substrate in order to have higher mechanical strength than the varistor body 110. The alumina substrate not only has high mechanical strength but also efficiently releases heat generated in the varistor body 110.

For example, a length (L1) of the varistor body 110 may be longer than a half of a length (L2) of the substrate 140. A distance (D1, D2 and D3) between the first electrode 121 and the second electrode 122 in the varistor body 110 may correspond to the breakdown voltage of the varistor 100a, 100b and 100c. The length (L1) of the varistor can be more freely designed as the length (L1) thereof increases. The substrate 140 can more effectively complement the mechanical strength of the varistor body 110, which may become lower as the length (L1) of the varistor body 110 increases.

For example, a thickness (T1) of the varistor body 110 may be smaller than 1/10 of the length (L1) of the varistor body 110. The varistor 100a, 100b and 100c can be more easily miniaturized/thinner as the thickness (T1) of the varistor body 110 is reduced with respect to the length (L1) thereof. The substrate 140 can more effectively complement the strength of the varistor body 110, which may be reduced as the thickness (T1) of the varistor body 110 decreases with respect to the length (L1) thereof. A thickness (T2) of the substrate is not particularly limited.

For example, the varistor body 110 may be formed by ZnO—Bi₂O₃-base liquid-phase sintering. In this regard, the substrate 140 can be made thinner with relatively high adhesion to the substrate 140 and reliability when formed by liquid-phase sintering.

As the mechanical strength of the varistor body 110, which is to be formed by liquid-phase sintering, can be complemented by the substrate 140, the varistor 100a, 100b and 100c according to an example embodiment may be thinner while having improved mechanical strength.

For example, the varistor body 110 may have further improved mechanical strength when formed by ZnO—Pr₆O₁₁-base solid-phase sintering.

Here, the varistor body 110 may include cobalt (Co). The cobalt may have an amorphous structure on a contact interface with the substrate 140.

Accordingly, bonding property of the varistor body 100 to the substrate 140 may be improved, and the varistor 100a, 100b and 100c according to an example embodiment can have further improved reliability.

Referring to FIGS. 1, 2B and 3B, the first and second electrodes 121 and 122 of the varistor 100b may have a first length (L1b) and a second length (L2b) and also a first extension length (Bw1b) and a second extension length (Bw2b) on the varistor body 110. For example, an extension length of an electrode may refer to a length of a portion of the electrode extending on or being in contact with the varistor body 110.

Referring to FIGS. 2A and 3A, the first and second electrodes 121 and 122 of the varistor 100a may have relatively small first and second lengths (L1a and L2a) and also relatively short first and second extension lengths (Bw1a, Bw2a) on the varistor body 110. Accordingly, the distance (D1) between the first and second electrodes 121 and 122 may become relatively longer. Referring to FIGS. 2C and 3C, the first and second electrodes 121 and 122 of the varistor 100c may have relatively long first and second lengths (L1c and L2c) and also relatively long first and second extension lengths (Bw1c and Bw2c) on the varistor body 110. Accordingly, the distance (D3) between the first and second electrodes 121 and 122 may be relatively reduced.

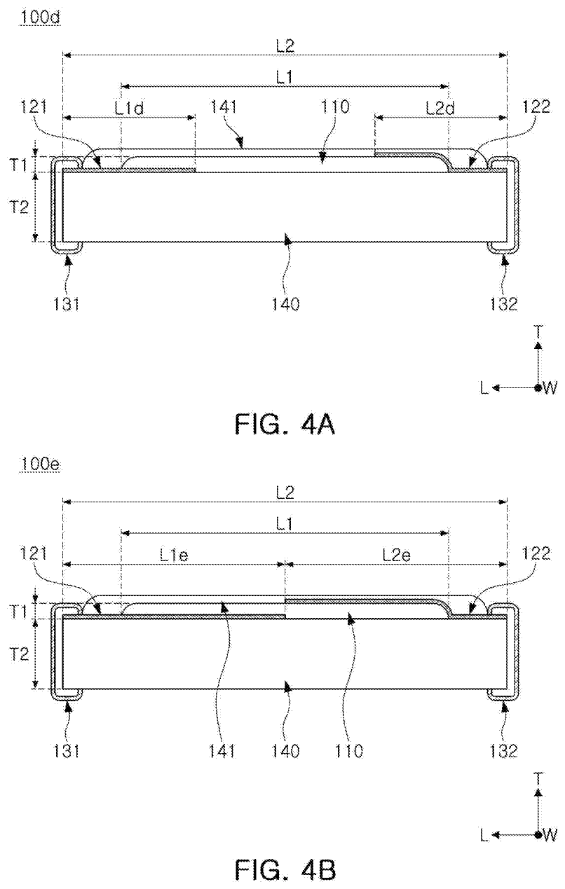

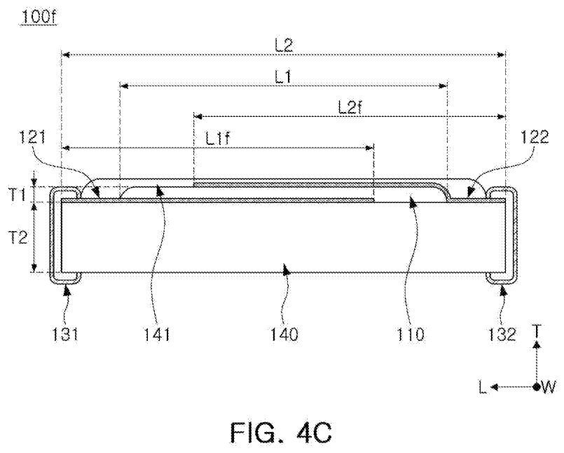

FIGS. 4A to 4C are side views of up and down displacement of electrodes of a varistor according to an example embodiment.

Referring to FIGS. 4A to 4C, each of a varistors 100d, 100e and 100f according to an example embodiment includes a varistor body 110, a first electrode 121, a second electrode 122, a first terminal 131, a second terminal 132, an insulating layer 141 and a substrate 140. In the varistor body 110, the first and second electrodes 121 and 122 may be disposed on different surfaces. For example, the first and second electrodes 121 and 122 may be disposed on different surfaces of the varistor body 110.

That is, at least a portion of the first electrode 121 is disposed on a lower side of the varistor body 110, and at least a portion of the second electrode 122 is disposed on an upper side of the varistor body 110.

Accordingly, since a distance between an edge of the first electrode 121 and an edge of the second electrode 122 can be more easily adjusted, the varistors 100d, 100e and 100f according to an example embodiment can have more finely-controlled breakdown voltage. The breakdown voltage may be lowered as extension lengths of the first and second electrodes 121 and 122 increases in the length direction.

For example, the first electrode 121 and the second electrode 122 may be in planar and bent forms, respectively. Accordingly, a connecting point of the first terminal 131 of the first electrode 121 and that of the second terminal 132 of the second electrode 122 may be positioned at the same height, and thus, the first and second terminals 131 and 132 may have a further stable structure. The varistors 100d, 100e and 100f according to an example embodiment can have further improved mechanical strength.

In addition, at least parts of the first electrode and the second electrode may overlap in the thickness direction.

Accordingly, the varistors 100d, 100e and 100f according to an example embodiment may have much greater capacitance, and may have various capacitances by adjusting a size of the overlapped region of the first and second electrodes 121 and 122 in the thickness direction.

Capacitance may increase as the extension lengths of the first and second electrodes 121 and 122 increase in the length direction.

A settling time of the varistor 100d, 100e or 100f according to an example embodiment until voltage stabilizes after a large current may be reduced as the capacitance of the varistor 100d, 100e or 100f increases. A maximum current of the varistor 100d, 100e or 100f may increase as the capacitance increases.

Accordingly, the varistors 100d, 100e and 100f according to an example embodiment may have various ESD noise absorption and various maximum currents by adjusting the overlapped region of the first electrode 121 and/or the second electrode 122.

Referring to FIG. 4B, the first and second electrodes 121 and 122 of the varistor 100e may have first and second lengths (Lie and L2e), respectively.

Referring to FIG. 4A, the first and second electrodes 121 and 122 of the varistor 100d may have relatively short first and second lengths (L1d and L2d), respectively, as compared to the varistor 100e or 100f.

Referring to FIG. 4C, the first and second electrodes 121 and 122 of the varistor 100f may have relatively long first and second lengths (L1f and L2f), respectively, as compared to the varistor 100d or 100e. Accordingly, the first and second electrodes 121 and 122 may overlap in the thickness direction.

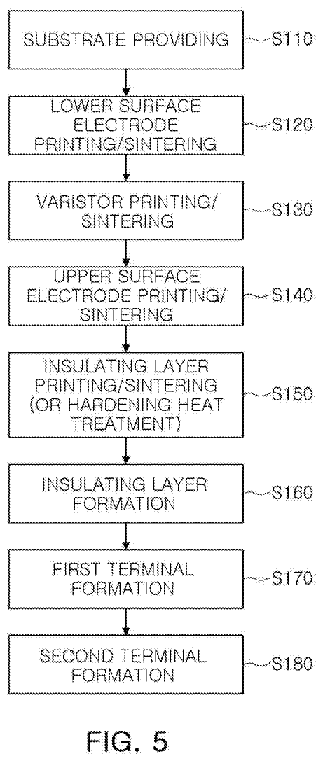

FIG. 5 is a flowchart illustrating a process of manufacturing a varistor according to an example embodiment.

Referring to FIG. 5, a varistor according to an example embodiment may be manufactured through at least some of substrate providing (S110), lower surface electrode printing/sintering (S120), varistor printing/sintering (S130), upper surface electrode printing/sintering (S140), insulating layer printing/sintering (S150), insulating layer formation (S160), first terminal formation (S170) and second terminal formation (S180), but is not limited thereto.

A varistor paste may be manufactured.

The varistor paste can be manufactured by mixing a binder, a dispersant and a solvent through a 3-roll milling process to have various solid loading ranges (73% to 85%) and a viscosity of 100 kCps to 250 kCps.

The ceramic solid powder forming the paste may have a liquid sintering composition consisting of Bi₂O₃ and other various additives based on ZnO, a solid sintering composition consisting of various additives based on Pr₆O₁₁ and ZnO, or a sintered ceramic composition having other varistor characteristics.

A composition of the paste may include at least some of 8 ingredients of Zn, Bi, Sb, Co, Mn, Ni, Si and Zr. Among additives, at least some of Bi, Sb, Co, Mn and Ni, which are used to adjust the varistor characteristics, are weighed, ground and dispersed in advance according to a composition table and calcined at a pre-determined temperature (for example, 700° C.). Pre-calcined powder is then wet-ground to prepare calcined powder having a submicron-sized center particle diameter.

ZnO, the calcined powder, SiO₂ and ZrO₂ were weighed according to a weighing table and wet mixed, dried, and crushed to prepare solid powder or liquid powder for the varistor paste.

The prepared solid powder or liquid powder can be mixed with an ethylcellulose binder solution, a solvent and a dispersant to prepare as a paste through the 3-roll milling.

An electrode paste may be first printed and fired or the varistor paste may be printed according to a printing design and fired on the alumina substrate having dividing lines by component size, which are formed in L and W directions.

Subsequently, a supplementary electrode paste can be printed or a supplementary varistor paste can be printed according to a printing design and sintered to implement a structure in which electrodes are formed above and below or left and right to the sintered varistor body.

In the case in which the thickness of the varistor needs to be increased, a printing and sintering process can be performed at least twice.

An insulator (e.g., glass) is then printed so that the varistor body is not exposed and fully covered, followed by drying and sintering in order to form an insulating layer. After the insulating layer is formed, an epoxy insulator, or the like is printed and hardened to intensify the insulating layer. Alternatively, an epoxy is solely printed and hardened without the insulating layer, to form an insulating layer.

Two types of glass may be consecutively printed and heat-treated to form multi-glass insulating layers.

A substrate on which the insulating layer is formed can be first divided in a direction to which an electrode surface of a component on the substrate-dividing lines in the L and W directions to obtain a substrate body applicable to the external surfaces.

The first divided alumina substrate body was stacked on a jig to form a Ni electrode by sputtering. The Ni electrode-formed substrate body was then divided (second) by injecting into a divider so as to divide into individual components by the L*t surface. By plating Ni and Si to form termination electrodes, a varistor component can be manufactured.

Terminals can be formed by, in addition to sputtering, dipping the alumina substrate body, which has been first divided, in a terminal paste applied in a uniform thickness. The terminals are then sintered, second divided and plated to manufacture a varistor component.

The varistor according to an example embodiment of the present disclosure may have improved mechanical strength or a structure advantageous in miniaturization/slimming thereof.

While the example embodiments have been shown and described above, it will be apparent to those skilled in the art that modifications and variations could be made without departing from the scope of the present invention as defined by the appended claims.

What is claimed is:

1. A varistor, comprising:
a substrate;
a varistor body disposed on one surface of the substrate;
first and second electrodes disposed on the varistor body and spaced apart from each other;
an insulating layer disposed on at least two of the first and second electrodes and the varistor body; and
first and second terminals disposed on first and second sides of the substrate opposing each other, electrically connected to the first and second electrodes, respectively, and spaced apart from each other,
wherein the substrate has a mechanical strength greater than that of the varistor body.

2. The varistor of claim 1, wherein the varistor body comprises ZnO and one or more selected from the group consisting of silicon (Si), bismuth (Bi), cobalt (Co), manganese (Mn), zirconium (Zr), antimony (Sb) and zinc (Zn).

3. The varistor of claim 1, wherein:
the substrate is an alumina substrate, and
the varistor body comprises cobalt,
wherein a surface of the varistor body in contact with the substrate comprises an amorphous structure.

4. The varistor of claim 1, wherein a length of the varistor body is longer than a half of a length of the substrate.

5. The varistor of claim 4, wherein a thickness of the varistor body is less than 1/10 of the length of the varistor body.

6. The varistor of claim 1, wherein
at least a portion of the first electrode is disposed on a lower side of the varistor body and between the varistor body and the substrate, and
at least a portion of the second electrode is disposed on an upper side of the varistor body.

7. The varistor of claim 6, wherein the at least portions of the first electrode and the second electrode overlap in a thickness direction.

8. The varistor of claim 6,
wherein the first electrode is in a planar form, and
the second electrode is in a bent form.

9. The varistor of claim 6,
wherein the first electrode is entirely in contact with the one surface of the substrate, and
the second electrode includes a portion in contact with the one surface of the substrate, and an extending portion extending onto the upper side of the varistor body such that a portion of the varistor body is disposed between the substrate and the extending portion of the second electrode.

10. The varistor of claim 1, wherein at least a portion of each of the first and second electrodes is bent and disposed on an upper side of the varistor body.

11. The varistor of claim 1, wherein the first electrode includes a portion in contact with the one surface of the substrate, and an extending portion extending onto the upper side of the varistor body such that a portion of the varistor body is disposed between the substrate and the extending portion of the first electrode, and
the second electrode includes a portion in contact with the one surface of the substrate, and an extending portion extending onto the upper side of the varistor body such that another portion of the varistor body is disposed between the substrate and the extending portion of the second electrode.

12. The varistor of claim 1, wherein the first and second terminals extend in a length direction along the one surface on which the varistor body is disposed, and
a width of each of the first and second electrodes is less than a width of each of the first and second terminals.

13. The varistor of claim 12, wherein a width of the varistor body is less than a width of each of the first and second electrodes.

14. The varistor of claim 13, wherein a width of the insulating layer is less than the width of each of the first and second terminals and greater than the width of each of the first and second electrodes.

15. The varistor of claim 1, wherein the first and second terminals respectively extend onto the one surface of the substrate and respectively cover end portions of the first and second electrodes disposed directly on the one surface of the substrate.
